(19) United States
(12) Patent Application Publication
(10) Pub. No.: US 2004/0264056 A1
(43) Pub. Date: Dec. 30, 2004

(54) Symmetric interconnect design for a flexure arm of a hard disk drive

(76) Inventors: Eunkyu Jang, Santa Clara, CA (US); Hyung Jai Lee, Cupertino, CA (US)

Correspondence Address: Samsung Information Systems America, 75 West Plumeria Drive, San Jose, CA, 95134, US

(21) Appl. No.: 10/606,727

(22) Filed: Jun. 26, 2003

(51) Int. Cl. G11B 5/48

(52) U.S. Cl. 360/245.9

(57) ABSTRACT

An improved interconnect design for a flexure arm of a hard disk drive is provided. A pair of conductive write traces and a pair of conductive read traces extend generally symmetrically about a center axis of the flexure arm. An inner pair of traces extend adjacent to the center axis of the flexure arm. One each of an outer pair of traces extend adjacent to a trace of the inner pair of traces. Symmetrically positioning the write and read traces on the flexure arm may prevent mechanical movement of the flexure arm when writing data. Windows etched in a stainless steel lamina are symmetric with the flexure arm. Symmetrically positioned windows in the stainless steel lamina may prevent imbalance of the flexure arm and may prevent or reduce both the generation of common mode signal and the thermal drift of the flexure arm during data write operations.

### BACKGROUND OF THE INVENTION

1. Field of the Invention

The present invention relates to an interconnection design for a flexure arm of a hard disk drive.

2. Background Information

Hard disk drives contain a plurality of magnetic heads that are coupled to rotating disks. The heads write and read information by magnetizing and sensing the magnetic fields of the disk surfaces. Typically the magnetic heads include a write element for magnetizing the disks and a separate read element for sensing the magnetic field of the disks. The read element is typically constructed using a magneto-resistive material that has a resistance that varies with the magnetic fields of the disk. Heads with magneto-resistive read elements are commonly referred to as magneto-resistive (MR) heads.

Each head, sometimes referred to as a head slider, is attached to a flexure arm to create a subassembly commonly referred to as a head gimbal assembly (HGA). The HGA's are attached to an actuator arm. The actuator arm has a voice coil motor that can move the heads across the surfaces of the disks.

Information is stored in radial tracks that extend across the surfaces of each disk. Each track is typically divided up into a number of segments or sectors. The voice coil motor and actuator arm can move the heads to different tracks of the disks and to different sectors of each track.

A suspension interconnect extends along the length of the flexure arm and connects the head to a preamplifier device of the voice coil motor. The suspension interconnect typically comprises a pair of conductive write traces and a pair of conductive read traces. Typically one pair of traces, such as the read traces, extend down one side of the flexure arm to the head and the remaining pair of traces extends down the other side of the flexure arm to the head.

When data is written, electrical current flows along the write traces to the head, causing the head to magnetize the disk. Heat is generated as current flows along the write traces. This heat can cause the write traces to expand. Forces applied to the flexure by the expansion of the write traces can cause changes to the geometry of the flexure by causing bending or torsion of the flexure. The changes in the geometry of the flexure may cause track misalignment errors when the read/write heads do not properly along with track on the disk, adversely affecting the writing and/or reading of data.

The write traces typically require a relatively high differential impedance, about 70-120 ohm, compared to a relatively low differential impedance, about 40-50 ohm, of the read traces. The high impedance of the write traces is created by etching a window through a stainless steel lamina of the flexure arm beneath the write traces. The window through the stainless steel lamina is beneath the write traces and adjacent a side of the flexure arm. This asymmetry of the stainless steel lamina may unbalance the flexure arm and induce common mode signals, with may adversely affect the integrity of the write and read signals.

Accordingly, there exists a need for interconnect design that inhibits drift of the flexure arm while data is written and that does not cause mechanical unbalance of the flexure arm.

### BRIEF SUMMARY OF THE INVENTION

The invention includes an improved interconnect design of a flexure arm. A pair of conductive write traces and a pair of conductive read traces extend roughly symmetrically about a center axis of the flexure arm. An inner pair of traces, such as the write traces, extend adjacent to the center axis of the flexure arm. One each of an outer pair of traces extend adjacent to a trace of the inner pair of traces.

As current flows along the write traces heat is generated that can cause the write traces to expand. The expansion of the write traces can cause changes to the geometry of the flexure, known as thermal drift. Thermal drift of the flexure may result in track misalignment errors when the read/write heads do not properly align with tracks on the disk, adversely affecting the writing and/or reading of data. The negative effects of thermal drift may be reduced by symmetrically positioning the write and read traces on the flexure arm which may reduce mechanical movement of the flexure arm when writing data.

High impedance of the write traces is created by etching a window through a stainless steel lamina beneath them. One or more windows may be etched through the stainless steel lamina, determined by the positioning of the write traces on the flexure arm. Windows etched in the stainless steel lamina are symmetrical with the flexure arm since the write traces are positioned symmetrically along the flexure arm. Symmetrically positioned windows in the stainless steel lamina may prevent imbalance of the flexure arm and may prevent or reduce both the generation of common mode signals and the thermal drift of the flexure arm during data write operations.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, in which:

FIG. 1 is a top view of an embodiment of a hard disk drive of the invention;

FIG. 2 is an enlarged bottom view of a flexure arm of the invention;

FIG. 3 is an enlarged view of a head slider coupled to the flexure arm showing conductive write and read traces coupled to the head slider;

FIG. 4 is a plan view showing bond pads of a head slider; and

FIG. 5 and FIG. 6 are cross sectional views of different embodiments of the invention.

### DESCRIPTION OF THE PREFERRED EMBODIMENTS

The following description is provided to enable any person skilled in the art to make and use the invention and sets forth the best modes presently contemplated by the inventors of carrying out the invention. Various modifications, however, will remain readily apparent to those skilled in the art, since the generic principles of the present invention have been defined herein.

The invention includes an improved interconnect design for a flexure arm of a hard disk drive. In one embodiment a pair of conductive write traces and a pair of conductive read traces extend roughly symmetrically about a center axis of the flexure arm. An inner pair of traces extend adjacent to the center axis of the flexure arm. Each trace of an outer pair of traces extends adjacent to a trace of the inner pair of traces. Symmetrically positioning the write and read traces on the flexure arm may prevent mechanical movement of the flexure arm when writing data.

Windows are etched in a stainless steel lamina beneath the write traces and are symmetric with the flexure arm. Symmetrically positioned windows in the stainless steel lamina may prevent imbalance of the flexure arm and may prevent or reduce the generation of common mode signals.

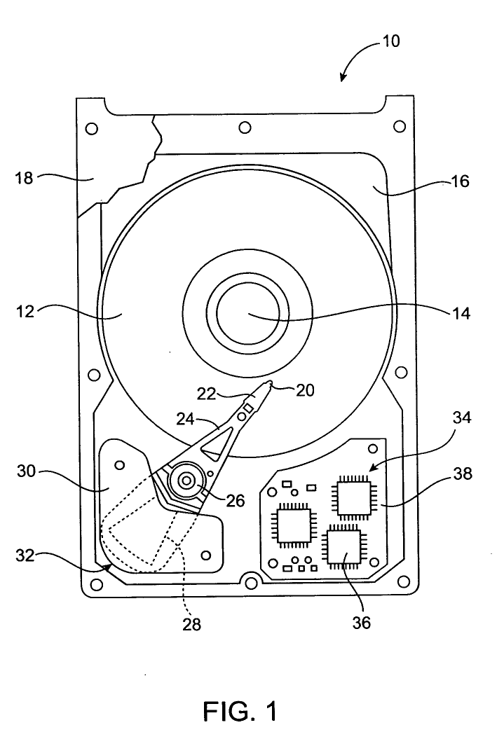

Referring to the drawings, more particularly by reference numbers, FIG. 1 shows an embodiment of a hard disk drive 10 of the present invention. The hard disk drive 10 may include one or more magnetic disks 12 that are rotated by a spindle motor 14. The spindle motor 14 may be mounted to a base plate 16 of the drive 10. The disk drive 10 may further include a cover 18 that encloses the disks 12.

The disk drive 10 may include a plurality of head sliders, or heads, 20 located adjacent to the disks 12. The heads 20 may have separate write and read elements (both not shown) that magnetize and sense the magnetic field of the disks 12.

Each head may be gimbal mounted to a flexure arm 22 as part of a head gimbal assembly (HGA). The flexure arms 22 are attached to an actuator arm 24 that is pivotally mounted to the base plate 16 by a bearing assembly 26. A voice coil 28 is coupled to a magnet assembly 30 to create a voice coil motor (VCM) 32. Providing a current to the voice coil 28 creates a torque that swings the actuator arm 24 and moves the heads 20 across the surfaces of the disks 12.

The disk drive 10 may further include a printed circuit board assembly 34. The printed circuit board assembly 34 may include a plurality of integrated circuits 36 coupled to a printed circuit board 38. The printed circuit board 38 is coupled to the voice coil 28, heads 20, and spindle motor 14 by wires (not shown).

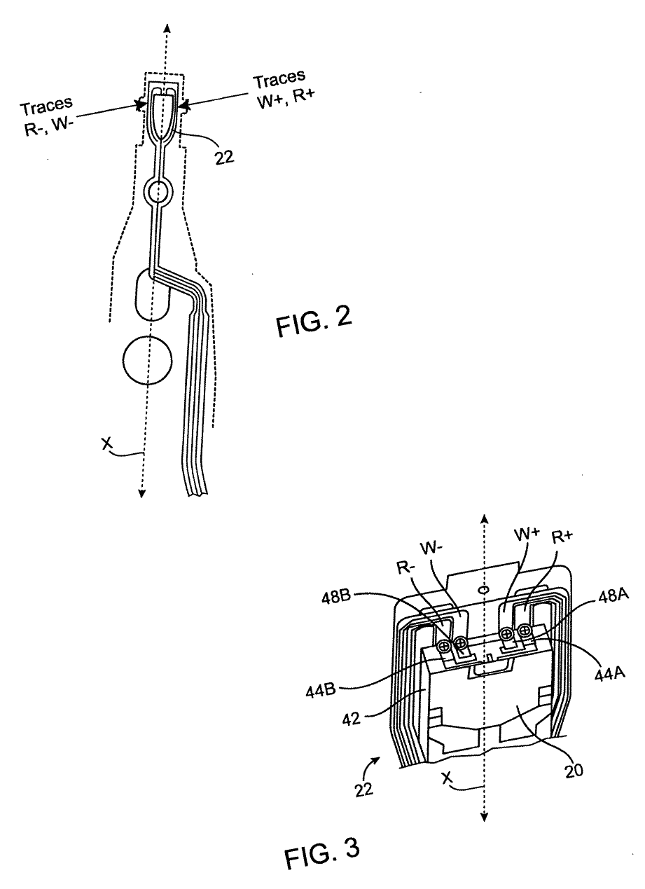

Referring to FIGS. 2 through 6, the flexure arm 22 of the present invention includes a pair of conductive write traces W+ and W− and a pair of conductive read traces R+ and R− that run symmetrically about a center axis X along the length of the arm 22. An inner pair of traces, shown generally at 40, extends from a preamplifier device (not shown) of the voice coil motor 32, along the length of the arm 22, to the head 20. The inner pair of traces 40 runs proximate to the center axis X of the flexure arm 22, along sides 42 of the head 20, and connects to an outer pair of bonds pads 44A, 44B of the head 20. Each trace of an outer pair of traces, shown generally at 46, runs adjacent to a trace of the inner pair of traces 40 of the same electrical polarity and couples to one of an inner pair of bond pads 48A, 48B of the head 20.

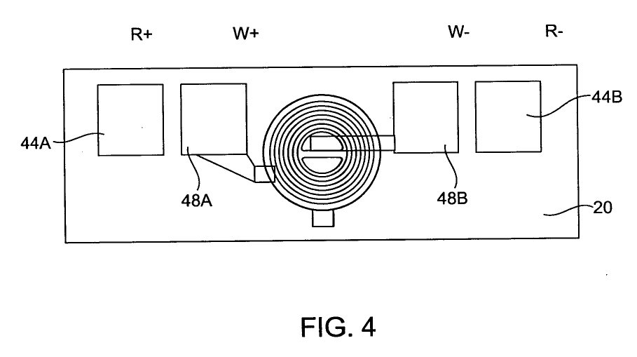

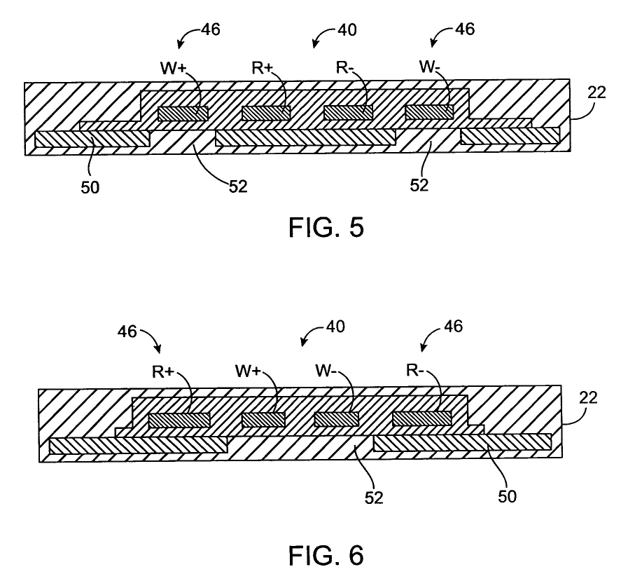

In the embodiment shown in FIG. 3, FIG. 4, and FIG. 5, the conductive write traces W+ and W− comprise the outer pair of traces 46 and the conductive read traces R+ and R− comprise the inner pair of traces 40. In this embodiment, the read traces R+ and R− extend from the voice coil motor 32, run generally parallel to the center axis X and couple to the outer pair of bond pads 44A, 44B.

The conductive write trace W+ extends from the voice coil motor 32, runs adjacent to the read trace R+, and is connected to an inner bond pad 48A. Similarly, the conductive write trace W− extends from the voice coil motor 32, runs adjacent to the read trace R−, and is connected to inner bond pad 48B.

As current flows along the write traces W+, W−, heat is generated that can cause the write traces W+, W− to expand. The expansion of the write traces W+, W− can cause the flexure are 22 to twist or bend. Symmetrically positioning the write and read traces W+ and W−, R+ and R− on the flexure arm 22 may prevent mechanical movement of the flexure arm 22 due to expansion of the write traces W+, W−, when writing data. Alternatively, separation of the write traces W+, W− may reduce localized head build up, thus reducing the amount of expansion experience bye the write traces W+, W−.

FIG. 5 and FIG. 6 show a stainless steel lamina 50 beneath the conductive traces W+, W−, R+, R− of the flexure arm 22. The write traces W+, W− require a high differential impedance, typically about 70-120 ohm, compared to a typical low differential impedance, about 40-50 ohm, of the read traces R+ and R−. The high impedance of the write traces W+, W− is created by etching at least one window 52 through the stainless steel lamina 50 of the flexure arm 22 beneath the write traces W+, W−. The window 52 is etched through the stainless steel lamina 50 during fabrication of the flexure arm 22 using well known methods.

In the embodiment shown in FIG. 5, the write traces W+, W− comprise the outer pair of traces 46 and are separated by the read traces R+, R−. A window 52 is etched beneath each write trace W+, W− to provide the desired impedance. In FIG. 5, the write traces W+, W− comprise the inner pair of traces 40 and run adjacent to each other. In this embodiment a single window 52 is etched beneath both write traces W+, W− to provide the desired impedance. In each embodiment, windows 52 etched in the stainless steel lamina 50 are symmetric about the center axis X of the flexure arm 22. Symmetrically positioned windows 52 in the stainless steel lamina 50 may prevent imbalance of the flexure arm 22 and may prevent or reduce both the generation of common mode signals and the thermal drift of the flexure arm during data write operations.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A interconnect for a flexure arm of a hard disk drive comprising:
a flexure arm coupled to an actuator arm pivotally mounted to a base plate via a bearing assembly;
a head slider gimbal mounted to the flexure arm;
a voice coil motor comprising a voice coil coupled to a magnet assembly;
an inner pair of conductive traces disposed along the flexure arm, the inner pair of traces conveying electrical current from the voice coil to the head slider; and
an outer pair of conductive traces disposed along the flexure arm, the outer pair of traces conveying electrical current from the voice coil to the head slider.

2. The interconnect of claim 1 wherein the inner pair of conductive traces and outer pair of conductive traces are symmetrical about a center axis of the flexure arm.

3. The interconnect of claim 2 wherein the inner pair of conductive traces comprise a pair of write traces for conveying current when data is written and the outer pair of conductive traces comprise a pair of read traces for conveying current when data is read.

4. The interconnect of claim 3 further comprising:
a stainless steel lamina extending the length of the flexure arm; and
a window etched in the stainless steel lamina adjacent to the pair of write traces to provide high impedance of the write traces.

5. The interconnect of claim 4 wherein the window etched in the stainless steel lamina is symmetrical about the center axis of the flexure arm.

6. The interconnect of claim 2 wherein the inner pair of conductive traces comprise a pair of read traces for conveying current when data is read and the outer pair of conductive traces comprise a pair of write traces for conveying current when data is written.

7. The interconnect of claim 6 further comprising:
a stainless steel lamina extending the length of the flexure arm; and
a window etched in the stainless steel lamina adjacent to each write trace of the pair of write traces such that a pair of windows are etched in the stainless steel lamina, the window etched in the stainless steel lamina to provide high impedance of the write traces.

8. The interconnect of claim 7 wherein the pair of windows etched in the stainless steel lamina are symmetrical about the center axis of the flexure arm.

9. A symmetric interconnect for a flexure arm of a hard disk drive comprising:
a flexure arm coupled to an actuator arm pivotally mounted to a base plate via a bearing assembly;
a head slider gimbal mounted to the flexure arm;
a voice coil motor comprising a voice coil coupled to a magnet assembly;
an inner pair of conductive traces coupled to the voice coil motor and to the head slider for conveying electrical current between the voice coil and head slider, the inner pair of traces extending the length of the flexure arm and symmetrical about a center axis thereof; and
an outer pair of conductive traces coupled to the voice coil motor and to the head slider for conveying electrical current between the voice coil and head slider, a trace of the outer pair of conductive traces extending the length of the flexure arm adjacent to a like electrical polarity trace of the inner pair of traces and a remaining trace of the outer pair of conductive traces extending the length of the flexure arm adjacent to a like electrical polarity trace of the inner pair of traces, such that the outer pair of traces are symmetrical about the center axis of the flexure arm.

10. The interconnect of claim 9 wherein each trace of the outer pair of conductive traces extends adjacent a like trace of the inner pair of traces and is interposed between a side of the flexure arm and the like trace of the inner pair of traces.

11. The interconnect of claim 9 wherein the inner pair of conductive traces comprise a pair of write traces for conveying current when data is written and the outer pair of conductive traces comprise a pair of read traces for conveying current when data is read.

12. The interconnect of claim 11 further comprising:
a stainless steel lamina extending the length of the flexure arm; and
a window etched in the stainless steel lamina adjacent to the pair of write traces to provide high impedance of the write traces.

13. The interconnect of claim 12 wherein the window etched in the stainless steel lamina is symmetrical about the center axis of the flexure arm.

14. The interconnect of claim 9 wherein the inner pair of conductive traces comprise a pair of read traces for conveying current when data is read and the outer pair of conductive traces comprise a pair of write traces for conveying current when data is written.

15. The interconnect of claim 14 further comprising:
a stainless steel lamina extending the length of the flexure arm; and
a window etched in the stainless steel lamina adjacent to each write trace of the pair of write traces such that a pair of windows are etched in the stainless steel lamina, the window etched in the stainless steel lamina to provide high impedance of the write traces.

16. The interconnect of claim 15 wherein the pair of windows etched in the stainless steel lamina are symmetrical about the center axis of the flexure arm.

17. A flexure arm assembly comprising:
a flexure arm having a center axis;
a first pair of conductive traces disposed along the center axis with one trace of each pair on opposite sides of the center axis; and
a second pair of conductive traces disposed along the center axis with one trace of each pair on opposite sides of the center axis.

18. The flexure assembly of claim 17 wherein each trace of the first pair of traces are positioned symmetrically on opposite sides of the center axis.

19. The flexure assembly of claim 18 wherein each trace of the second pair of traces are positioned symmetrically on opposite sides of the center axis.

20. The flexure assembly of claim 17 further comprising a window etched symmetrically about the center axis of the flexure arm.
